(19) United States
(12) Patent Application Publication
(10) Pub. No.: US 2016/0090969 A1
(43) Pub. Date: Mar. 31, 2016

(54) Method for creating a propulsive force

(71) Applicant: Alec BLANCHARD, Lutry (CH)

(72) Inventor: Alec Blanchard, Lutry (CH)

(21) Appl. No.: 14/892,216

(22) PCT Filed: May 22, 2014
(86) PCT No.: PCT/IB2014/000840

§ 371 Date: Nov. 19, 2015

(30) Foreign Application Priority Data
May 27, 2013 (CH) 01016/13

(51) Int. Cl. F03G 3/08

(52) U.S. Cl. CPC F03G 3/08

(57) ABSTRACT

A method for creating a propulsive forced based on modifying the angular momentum of rotating masses by varying the radius of rotation of same.

The present invention is directed to a process to create a propulsive force. The principle of the process is based on the modification of the angular momentum of one or more rotating masses by changing the radius of rotation for these rotating masses. The detailed principle of the process is explained below.

One or more masses are in motion by a rotational movement around an axis. On one or on a part of a half-rotation, an increasing centripetal force is applied to the masses, having the effect of reducing the rotational radius of the masses, and to increase the speed and the kinetic energy of these rotating masses. It is important that no mechanical constraints interfere with the angular acceleration of these masses while the masses are subjected to the increasing centripetal force. On the other or on a part of the other half-rotation, the rotating masses are subjected to a decreasing centripetal force that will increase the rotational radius of the masses and will reduce the speed and their kinetic energy. As described before, no mechanical constraint should interfere with the angular deceleration of these masses while the rotational radius of the rotating masses increases. On the arc that is formed by a first location where the increasing centripetal force is applied to the mass, and a second location where the decreasing centripetal force is applied to the mass, another centripetal force is evidently present that maintains the acceleration of the rotating mass along the reduced radius of rotation. Analogously, on the arc of the circle between a first location where the decreasing centripetal force is applied to the mass and a second location where the increasing centripetal force is applied to the mass, a centripetal force is present that maintains the deceleration of the rotating mass along the increased radius of rotation.

The strength of the propulsion force is based on a function that depends on the number of masses, their mass, their speed, the radius of rotation, and the difference between the radii of rotation that have been increased or decreased, as well as the number of systems that have implemented the above described process.

The direction of the propulsive force can be modified by changing the orientation of the force application locations where the increasing or decreasing centripetal forces are applied.

If the rotating masses are particles that have a rotational speed close to the speed of light, the reduction of the rotational radius would not increase the rotational speed of the particles, but will increase the mass (relativity theory).

The increasing centripetal force increases the speed and the kinetic energy of the rotating masses, and analogously, the decreasing centripetal force decreases their speed and their kinetic energy. By coupling these two forces, the process can save energy. The “coupling” of these two forces is better understood based on the two following embodiments that implement the process described below.

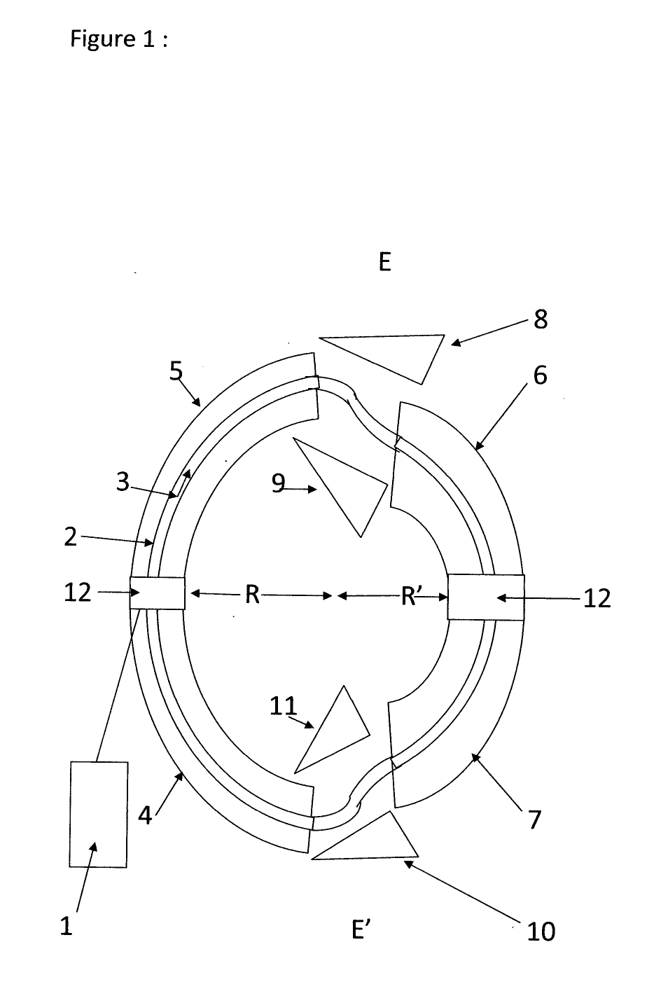

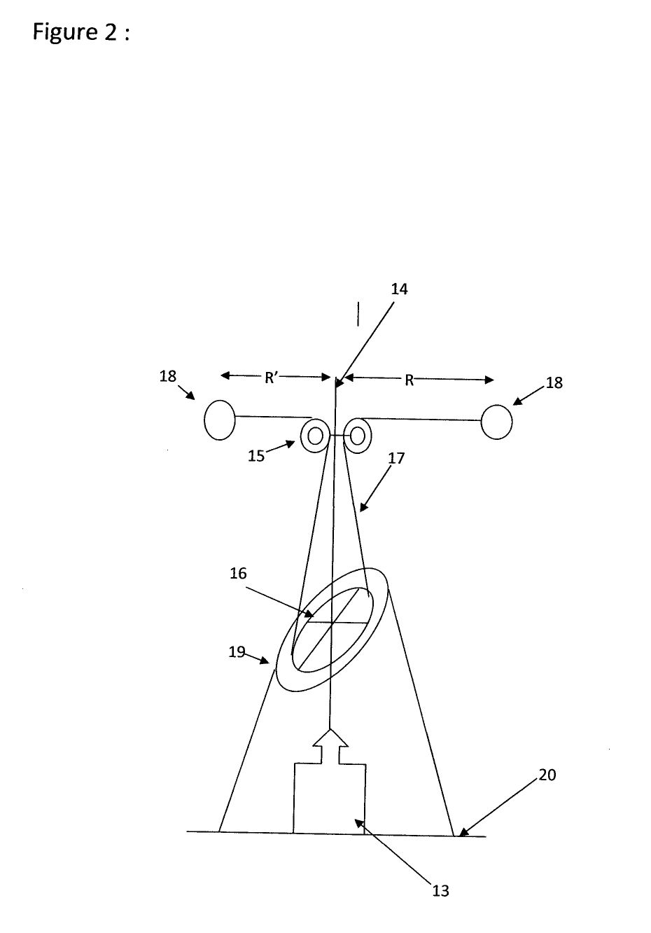

Two embodiments of above-described process are given by way of non-limiting examples. The first embodiment is shown schematically with FIG. 1. The second embodiment is also depicted schematically as a side view in FIG. 2.

The first embodiment of the process, schematically represented by FIG. 1, includes an electron injector 1 that feeds a vacuum chamber 2. The trajectory 3 of the electrons is determined by electromagnets 4 and 5 that are configured to maintain the electrons on a rotational radius R, and by electromagnets 6 and 7 that are configured to maintain the electrons on a rotational radius R′ that is smaller than rotational radius R. At the location E, the system includes a centripetal electric field that is increasing including a cathode 8 and an anode 9, the centripetal electric field capable of moving the electrons from rotational radius R to rotational radius R′. This reduction in the rotational radius for the electrons increases their angular momentum by increasing their rotational speed or their mass (relativity theory). At the location E′, the system includes a decreasing centripetal electric field including a cathode 10 and an anode 11 capable of moving the electrons from rotational radius R′ to rotational radius R. Thereby, the increasing and decreasing centripetal forces are only applied on a part of the half-rotation, as described in Claim 1. The system also includes two linear acceleration cavities 12, acting as a synchrotron, so that the electrons can be accelerated to the desired velocity and for maintaining the velocity. To compensate the energy, the cathodes 8 and 10 are electrically connected, as well as the anodes 9 and 11. This is the “coupling” of the increasing and decreasing centripetal forces, described above in the specification and as shown in Claim 4. The system can be arranged in space such that the force generated by the system can be oriented in a desired way.

The second embodiment of the system that implements the process is schematically represented by the side view in FIG. 2, the system includes a motor 13 that drives an axis of rotation 14. To this axis 14, pulleys 15 are attached thereto (only two are shown in the figure) and a disk 16 in an arrangement that axis 14, the pulleys 15, and the disk 16 rotate with the same constant rotational speed. Cables 17 that have the same length (only two are shown in the figure) are attached to disk 16 and are passed through corresponding pulleys 15 with masses 18 attached to the end of each cable 17, the masses 18 having the same weight. The disk 17 is configured to be orientable around axis 14. The disk 17 is also configured to slide in a groove of a ring 19, the ring 19 not being able to turn with axis 14. The ring 19 is connected to frame 20 and allows to incline disk 16 such that it causes an elevation effect on the corresponding cable 17, thereby reducing the rotational radius of the corresponding mass 18 that are located on the left side R′ of FIG. 2 and increasing its rotational speed and kinetic energy, and analogously, in the right side R of FIG. 2, the rotational radius of the mass 18 is increased that leads to a decreased rotational speed and kinetic energy. It appears that in the second embodiment, the increasing and decreasing centripetal forces are applied to the entire length of a half-rotation of the masses, as shown in Claim 1. The angular speed acceleration and deceleration of the masses 18 is possible without significant mechanical losses because the cables 17, other than passing through a corresponding pulley 15, are free. By the rotation and the inclination angle of disk 16, the increasing and decreasing centripetal forces are created. These two forces are coupled together, as shown in Claim 4, because the cables 17 are connected to each other via the disk 16. The intensity of the propulsive force depends on the number of masses 18, the weight of the masses, the rotational speed of the masses, the radius of rotation, and the difference of the rotational radii that depends from the inclination angle of the disk 16. Moreover, the orientation of the inclination of the disk 16 also orientates the propulsive force of the system that implements the process.

1-5. (canceled)

6. A method for generating a propulsive force comprising the steps of:
reducing a first rotational radius of a first object that is performing a first rotational movement around a rotational center axis by applying a first centripetal force to the first object at a first location along a trajectory of the first object, to increase at least one of a speed of the first rotational movement and a mass of the first object;
increasing a second rotational radius of a second object that is performing a second rotational movement around the rotational center axis by applying a second centripetal force to the second object at a second location along a trajectory of the second object, to decrease at least one of a speed of the second rotational movement and a mass of the second object; and
generating the propulsive force that depends on the mass of the first and second object, the first and second rotational radii, and the speed of the first and second object.

7. The method according to claim 6, further comprising the step of:
modifying a direction of the propulsive force by changing an application direction of the first and the second centripetal force.

8. The method according to claim 6, further comprising the step of:
coupling a first force generator that generates the first centripetal force, and the second force generator that generates the second centripetal force to save energy.
